(19) United States
(12) Patent Application Publication
(10) Pub. No.: US 2023/0247498 A1
(43) Pub. Date: Aug. 3, 2023

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/001,538

(22) PCT Filed: Jun. 12, 2020
(86) PCT No.: PCT/CN2020/095820

§ 371 Date: Dec. 12, 2022

(51) Int. Cl. H04W 36/00; H04W 24/10; H04W 24/08; H04W 36/36; H04W 36/30

(52) U.S. Cl. CPC H04W 36/0085; H04W 24/10; H04W 24/08; H04W 36/36; H04W 36/304

(57) ABSTRACT

Embodiments of the present disclosure relate to communication. According to embodiments of the present disclosure, a terminal device is configured with an extended period which delays accessing to a moving network device. Further, if the terminal device is connected with the moving network device, the terminal device is configured with less frequent measurements. In this way, unnecessary handover/cell reselection is avoided. A larger number of signaling overheads are reduced.

### TECHNICAL FIELD

Embodiments of the present disclosure generally relate to the field of telecommunication, and in particular, to methods, devices, and computer readable medium for communication.

### BACKGROUND

In communication systems, a handover is a process in telecommunications and mobile communications in which a connected cellular call or a data session is transferred from one cell site (base station) to another without disconnecting the session. Handovers are a core element in planning and deploying cellular networks. It allows users to create data sessions or connect phone calls on the move. This process keeps the calls and data sessions connected even if a user moves from one cell site to another. Further, a technology named “cell reselection” has also been proposed, which is a kind of mechanism to change cell after a terminal device is camped on a cell and stay in IDLE mode. This is to let terminal device get connected to cell which has the best condition among all the cells to which the terminal device is allowed to camp on. However, in a scenario of fast moving, the handover and the cell reselection may occurre frequently, which is not expected.

### SUMMARY

In general, example embodiments of the present disclosure provide a solution for preventing frequent handover and/or cell re-selection.

In a first aspect, there is provided a method for communication. The communication method comprises: receiving, at a terminal device, a configuration from a first network device, the configuration indicating a period for delaying an access to a second network device; measuring, based on the period, a quality of a link between the terminal device and the second network device; and transmitting information of the quality to the first network device.

In a second aspect, there is provided a method for communication. The communication method comprises determining, at a first network device, a configuration indicating a period for delaying a terminal device accessing to a second network device; transmitting the configuration to the terminal device; and receiving, from the terminal device, information of a quality of a link between the terminal device and the second network device.

In a third aspect, there is provided a method for communication. The communication method comprise: receiving, at a second network device and from a first network device, system information indicating a measurement parameter for measurements on a link quality between a terminal device and the second network device; and transmitting the system information to the terminal device.

In a fourth aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device, a configuration from a first network device, the configuration indicating a period for delaying an access to a second network device; measuring, based on the period, a quality of a link between the terminal device and the second network device; and transmitting information of the quality to the first network device.

In a fifth aspect, there is provided a first network device. The first network device comprises a processing unit; and a memory coupled to the processing unit and storing instructions thereon, the instructions, when executed by the processing unit, causing the first network device to perform acts comprising: determining a configuration indicating a period for delaying a terminal device accessing to a second network device; transmitting the configuration to the terminal device; and receiving, from the terminal device, information of a quality of a link between the terminal device and the second network device.

In a sixth aspect, there is provided a second network device. The second network device comprises a processing unit; and a memory coupled to the processing unit and storing instructions thereon, the instructions, when executed by the processing unit, causing the second network device to perform acts comprising: receiving, from a first network device, system information indicating a measurement parameter for measurements on a link quality between a terminal device and the second network device; and transmitting the system information to the terminal device.

In a seventh aspect, there is provided a computer readable medium having instructions stored thereon, the instructions, when executed on at least one processor, causing the at least one processor to carry out the method according to any one of the first aspect, second aspect or third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for preventing frequent handover and/or cell re-selection according to some embodiments of the present disclosure;

FIG. 3 illustrates a signaling flow for preventing frequent handover and/or cell re-selection according to some embodiments of the present disclosure;

FIG. 4 illustrates a signaling flow for preventing frequent handover and/or cell re-selection according to some embodiments of the present disclosure;

FIG. 5 illustrates a signaling flow for preventing frequent handover and/or cell re-selection according to some embodiments of the present disclosure;

FIG. 6 is a flowchart of an example method in accordance with an embodiment of the present disclosure;

FIG. 7 is a flowchart of an example method in accordance with an embodiment of the present disclosure;

FIG. 8 is a flowchart of an example method in accordance with an embodiment of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Due to expected larger bandwidth available for new radio (NR) systems compared to long-term evolution (LTE) systems, it creates an opportunity to develop and deploy integrated access backhaul (IAB) architecture for the fifth generation (5G) cellular networks in which the same infrastructure and spectral resources will be used for both access and backhaul. This may allow easier deployment of a dense network of NR cells in a more integrated manner by building upon many of control and data channels/procedures defined for providing access to terminal devices. Further, a mobile IAB will be introduced. The mobile IAB may be deployed in fast moving traffic vehicles, for example, high speed trains. As mentioned above, frequent handover and cell reselection are not expected. In a scenario of the mobile IAB, only passengers in the vehicles should be served by the mobile IAB. If other UEs are served by the mobile IAB in the vehicle, it will cause a large number of unnecessary very frequent handover signaling and cell-reselection.

According to conventional technologies, there may be several backup relay nodes in a fast moving vehicle to provide fast handover. Further, a preconfigured parameter for handover has also been proposed. However, it still cannot prevent unnecessary handover.

In order to solve at least part of the aforementioned problems, new technologies in preventing frequent handover and/or cell re-selection are needed. According to embodiments of the present disclosure, a terminal device is configured with a period which delays accessing to a moving network device. Further, if the terminal device is connected with the moving network device, the terminal device is configured with less frequent measurements. In this way, unnecessary handover/cell reselection is avoided. A larger number of signaling overheads are reduced.

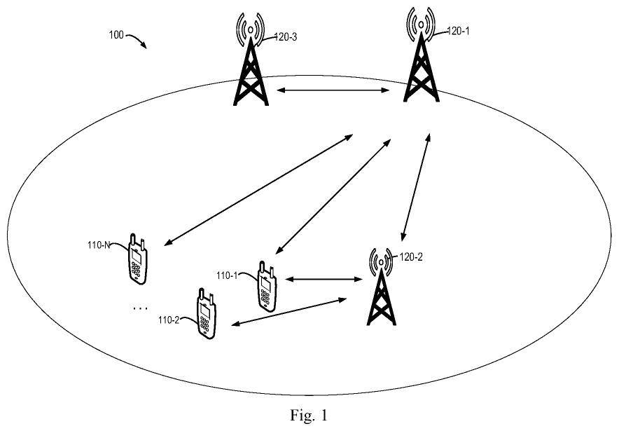

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises network terminal device 120-1, a network device 120-2, . . . , a network device 120-M, which can be collectively referred to as “network device(s) 120.” In some embodiments, the network device may be gNB. Alternatively, the network device may be IAB. The number M can be any suitable integer number. In the communication system 100, the network devices 120 and the terminal devices 110 can communicate data and control information to each other. Only for the purpose of illustrations, the network device 120-1 can be regarded as a source network device and the network device 120-2 can be regarded as a target network device. The numbers of terminal devices and network devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

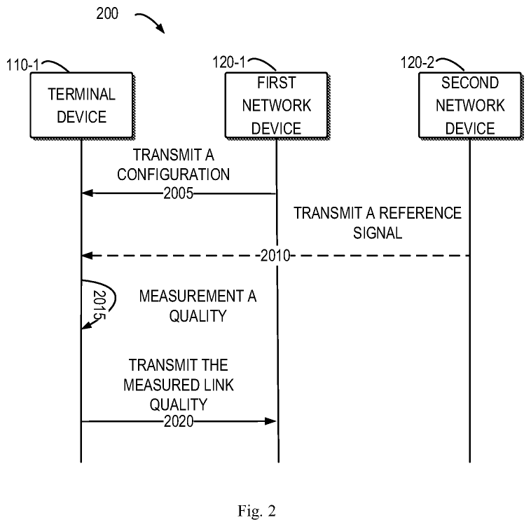

Embodiments of the present disclosure will be described in detail below. Reference is first made to FIG. 2, which shows a signaling chart illustrating process 200 among network devices according to some example embodiments of the present disclosure. Only for the purpose of discussion, the process 200 will be described with reference to FIG. 1. The process 200 may involve the terminal device 110-1, the first network device 120-1 and the second network device 120-2 in FIG. 1.

The first network device 120-1 transmits 2005 a configuration to the terminal device 110-1. The configuration indicates a period for delaying an access to the second network device 120-2. The period may be longer than current maximum period. In this way, unnecessary handover/cell reselection is avoided.

In some example embodiments, the period may be a time-to-trigger period. The time-to-trigger specifies the value range used for time to trigger parameter, which concerns the time during which specific criteria for the event needs to be met in order to trigger a measurement report. For example, the time-to-trigger period may be longer than 5120 ms. Only as an example, the time-to-trigger may be extended with 10240 ms and/or 20480 ms. It should be noted that the extended time-to-trigger period may comprise any suitable period.

Alternatively or in addition, the configuration may a cell-reselection period. The maximum value for the cell-reselection period may be bigger than the maximum value for a current cell-reselection period. By way of example, the maximum value for the current cell-reselection period may be 7 seconds, the maximum value for the cell-reselection period may be any suitable value which is bigger than 7 seconds. The configuration may indicate an offset to the current cell-reselection period. For example, if the current cell-reselection period is 7 seconds and the offset is 8 seconds, it means that the cell-reselection period is 15 seconds. Alternatively, the configuration may indicate an explicit value of the cell-reselection period.

In some example embodiments, the second network device 120-2 may use a dedicated frequency (for example, unlicensed spectrum). The period may be only applicable to the dedicated frequency of the second network device 120-2.

The second network device may transmit 2010 a reference signal to the terminal device 110-1. The reference signal can be used to measure a link quality. The reference signal can be any suitable types of signals.

The terminal device 110-1 measures 2015 a quality of a link between the terminal 110-1 device and the second network device 120-2 based on the period. For example, if the period may be a time-to-trigger period, the terminal device 110-1 may measure the quality of the link during the time-to-trigger period. Alternatively, if the period may be the cell-reselection period, the terminal device 110-1 may perform the cell reselection after the cell-reselection period. For example, the terminal device 110-1 may measure link qualities of one or more neighbor cells for the cell reselection. In some embodiments, the quality of the link may be reference signal received power (RSRP). Alternatively, the quality of the link may be reference signal received quality (RSRQ). In other embodiments, the quality of the link may be a received signal level.

The terminal device 110-1 transmits 2020 information of the quality to the first network device 120-1. For example, in an example embodiment where the period may be ad time-to-trigger period, if the quality measured during the time-to-trigger period exceeds a threshold quality, the terminal device 110-1 transmits the information of the quality to the first network device 120-1. Alternatively, if the period is cell-reselection period, the information of the quality may be transmitted after the measurement.

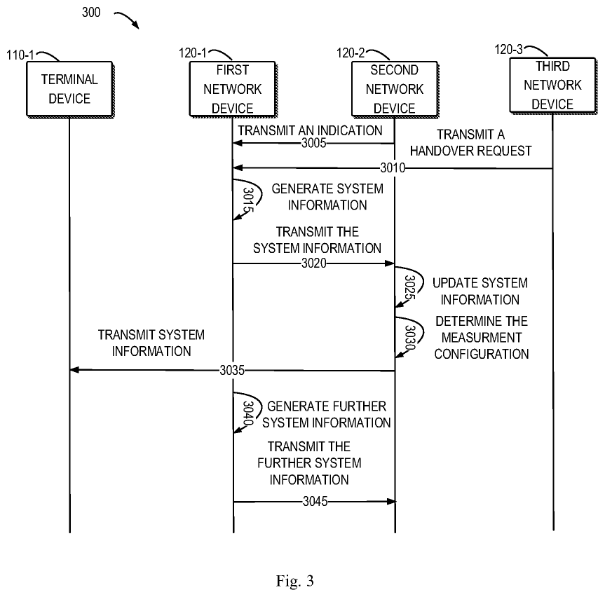

In a situation where the terminal device 110-1 in the vehicle can be attached to the mobile IAB (for example, the second network device 120-2), the terminal device 110-1 on board may perform handover/cell-reselection to neighbor cell less frequent. Reference is made to FIG. 3, which shows a signaling chart illustrating process 300 among network devices according to some example embodiments of the present disclosure. Only for the purpose of discussion, the process 300 may involve the terminal device 110-1, the first network device 120-1 and the second network device 120-2 in FIG. 1.

The first network device 120-1 may determine whether the second network device 120-2 moves in a speed which exceeds a threshold speed. In some example embodiments, the second network device 120-2 may transmit 3005 an indication to the first network device 120-1. The indication may indicate that the speed exceeds the threshold speed. For example, the indication may be transmitted in F1 application protocol (F1-AP) signaling. Alternatively or in addition, the third network device 120-3 may transmit 3010 a handover request to the first network device 120-1, which means that the speed exceeds the threshold speed.

The first network device 120-1 may generate 3015 system information which indicates a measurement parameter for measurements on the link quality. For example, the measurement parameter may be a measurement gap which is longer than current measurement gap. Alternatively or in addition, the measurement parameter may be a reduced number of times of measurements. It should be noted that the measurement parameter can be any suitable parameters. In this way, the terminal device 110-1 does not need to perform unnecessary measurement, thereby saving resources and power.

In some embodiments, the system information may indicate the cell-reselection periods. Alternatively or in addition, a drx-LongCycleStart Offset may be in the system information. It should be noted that embodiments of the present discourse are not limited to this aspect.

In other embodiments, the first network device 120-1 may generate more than one measurement configuration. For example, a first measurement configuration is generated, which is applicable when the second network device 120-2 moves in the speed exceeding the threshold speed. The terminal device 110-1 may perform less measurement based on the first measurement configuration. Alternatively or in addition, a second measurement configuration is generated, which is applicable when the second network device 120-2 moves in the speed below the threshold speed.

The first network device 120-1 may transmit 3020 the system information to the second network device 120-2. For example, the system information may be transmitted in F1-AP signaling. The second network device 120-2 may update 3025 previous system information based on the received system information. The second network device 120-2 may determine 3030 which one of the measurement configurations to be applied based on its speed. The second network device 120-1 may transmit 3035 the system information to the terminal device 110-1. For example, the system information may be broadcasted.

The first network device 120-1 may determine that a duration of the first network device 120-1 serving the second network device 120-2 exceeds a threshold value, which means the second network device 120-2 does not handover to other network devices. The first network device 120-1 may generate 3040 further system information. For example, the system information may indicate performing further measurement parameter for performing the measurement on the link quality. For example, the further measurement parameter may be a further measurement gap which is shorter than the measurement gap in the system information. Alternatively or in addition, the measurement parameter may be an increased number of times of measurements. Alternatively, the further system information may comprise a normal cell-reselection period. The first network device 120-1 may transmit 3045 the further system information to the second network device 120-2.

In an example embodiment, the second network device 120-2 may be configured with a conditional handover. By way of example, A4 measurement event is used to implement load balancing. For mobile network device (for example, the second network device 120-2), there are a lot of UEs attached, and the number of UE is un-predicted, which results the mobile network device consuming a lot of radio resources in Backhaul. So if the serving network device (for example, the first network device 120-1) is overloaded due to the access of mobile network device, the serving network device can configure A4 measurement event for the mobile network device as a CHO trigger. In some embodiments, the conditional handover configuration may indicate that conditional handover is triggered if quality of a link of a target network device is better than a threshold quality. Alternatively or in addition, the conditional handover configuration may indicate that the conditional handover is triggered if power changes of signals received from the first network device 120-1 exceed a threshold power during a predetermined period. The threshold power can be determined as any suitable power. The threshold quality can be any suitable quality. In this way, the load balancing of the first network device can be achieved. Further, since there is no modification to the terminal device, the CHO can also be compatible with conventional terminal devices.

In other embodiments, the condition of the CHO may comprise an A3 measurement event. Alternatively, the condition of the CHO may comprise an A5 measurement event. It should be noted that the CHO configuration may comprise any suitable conditions for the CHO.

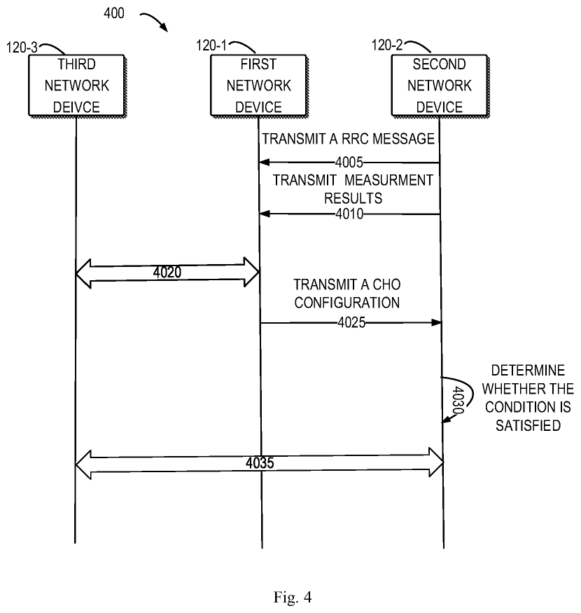

FIG. 4 shows a signaling chart illustrating process 400 among network devices according to some example embodiments of the present disclosure. Only for the purpose of discussion, the process 400 may involve the terminal device 110-1, the first network device 120-1 and the second network device 120-2 in FIG. 1.

The second network device 120-2 may initiate an access to the first network device 120-1 and transmit 4005 a radio resource control (RRC) message (for example, RRCSetiupComplete message comprising an iab-Nodeindication) to the first network device 120-1 in order to indicate the identity of the second network device 120-2.

The second network device 120-2 may transmit 4010 measurement results to the first network device. The measurement results may indicate qualities of the links between the second network device 120-2 and other network devices (for example, the third network device 120-3). The first network device 120-1 may determine a conditional handover configuration with the third network device 120-3. The conditional handover configuration may indicate a condition for handover to a target network device (for example, the third network device). The first network device 120-1 may prepare 4020 the handover associated with the third network device 120-3. For example, the first network device 120-1 may transmit a handover request to the third network device 120-3.

The first network device 120-1 may transmit 4025 the conditional handover (CHO) configuration associated with the third network device 120-3 to the second network device 120-2. For example, the first network device 120-1 may configure A4 measurement event as CHO triggering event to the second network device 120-2. In this way, the load balancing of the first network device 120-1 can be achieved.

The second network device 120-2 may determine 4030 whether the condition is satisfied. If the condition is satisfied, the second network device 120-2 may perform CHO to the third network device 120-3 based on the A4 event. In this way, load balance can be achieved. Table 1 below shows codes for the CHO triggering event.

TABLE 1

| | |
|---|---|
| CHO-TriggerConfig-r16 ::= | SEQUENCE { |
| cho-eventId | CHOICE { |
| cho-eventA3 | SEQUENCE { |
| a3-Offset | MeasTriggerQuantityOffset, |
| hysteresis | Hysteresis, |
| timeToTrigger | TimeToTrigger |

},

| | |
|---|---|
| cho-eventA5 | SEQUENCE { |
| a5-Threshold1 | MeasTriggerQuantity, |
| a5-Threshold2 | MeasTriggerQuantity, |
| Hysteresis | Hysteresis, |
| timeToTrigger | TimeToTrigger |

},

| | |
|---|---|
| cho-eventA4 | SEQUENCE { |
| a4-Threshold | MeasTriggerQuantity, |
| Hysteresis | Hysteresis, |
| timeToTrigger | TimeToTrigger |

},

| | |
|---|---|
| cho-eventA7 | SEQUENCE { |
| a7-Threshold | MeasTriggerQuantity, |
| Hysteresis | Hysteresis, |
| timeToTrigger | TimeToTrigger |

}

Alternatively, the second network device 120-2 may be configured with a new measurement event, in order to prevent ping-pong handover of the terminal device 110-2 between the first network device 120-1 and the second network device 120-2.

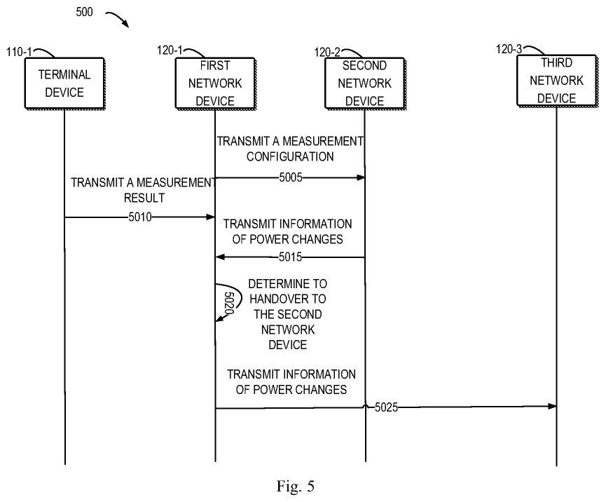

FIG. 5 shows a signaling chart illustrating process 500 among network devices according to some example embodiments of the present disclosure. Only for the purpose of discussion, the process 500 may involve the terminal device 110-1, the first network device 120-1 and the second network device 120-2 in FIG. 1.

The first network device 120-1 may transmit 5005 a measurement configuration to the second network device 120-2. The measurement configuration may be for measuring power changes of signals received from the first network device 120-1 in a predetermined period. The measurement configuration may indicate the predetermined period and a threshold power.

The measurement configuration may comprise the following: if Ms−Mslow−Hys>Thresh, the second network device 120-2 may enter the new measurement event. If Ms−Mslow+Hys<Thresh, the second network device 120-2 may leave the new measurement event. The parameter “Ms” represents the latest measurement result of the serving cell (for example, the first network device 110-1), the parameter “Mslow” represents the lowest measurement result of the serving cell during the last Tdelta, the parameter “Hys” represents the hysteresis parameter for this event (i.e. hysteresis as defined within reportConfigNR for this event), and the parameter “Thresh” represents the threshold parameter for this event.

The terminal device 110-1 may transmit 5010 the measured link quality of the second network device 120-2 to the first network device 120-1. The second network device may measure the power changes based on the measurement configuration and transmit 5015 information of the power changes to the first network device 120-1 if the power exceeds the threshold power during the predetermined period.

When the terminal device 110-1 reports the measurement result of the second network device 120-2 in a good radio quality, the first network device 120-1 may understand that the terminal device 110-1 is approaching the second network device 120-2. When the second network device 120-2 reports the changed power, the first network device 120-1 ay understand that the second network device 120-2 is moving. If the terminal device 110-1 is still in good radio quality, the first network device 120-1 may determine 5020 to handover the terminal device 110-1 to the second network device 120-2.

In some embodiments, the second network device 120-2 and the terminal device 110-1 may be served by different gNB. Only as an example, the second network device 120-2 may be served by the first network device 120-2 and the terminal device 110-1 may be served by the third network device 120-3. In this situation, the first network device 120-1 may transmit 5025 the information of power changes to the third network device 120-3. Table 2 below shows codes for handover UE to a mobile IAB.

TABLE 2

| MeasResult2NR-r16 ::= | SEQUENCE { |
|---|---|
| ssbFrequency-r16 | ARFCN-ValueNR |
| OPTIONAL, | |
| refFreqCSI-RS-r16 | ARFCN-ValueNR |
| OPTIONAL, | |
| measResultList-r16 | MeasResultListNR |
| } | |
| MeasResultNR ::= | SEQUENCE { |
| physCellId | PhysCellId |
| OPTIONAL, | |
| measResult | SEQUENCE { |
| cellResults | SEQUENCE{ |
| resultsSSB-Cell | MeasQuantityResults |
| OPTIONAL, | |
| resultsCSI-RS-Cell | MeasQuantityResults |
| OPTIONAL | |
| }, | |
| rsIndexResults | SEQUENCE{ |
| resultsSSB-Indexes | |
| ResultsPerSSB-IndexList | |
| OPTIONAL, | |
| resultsCSI-RS-Indexes | |
| ResultsPerCSI-RS-IndexList | |
| OPTIONAL | |
| } | |
| OPTIONAL | |
| }, | |
| ..., | |
| [[ | |
| cgi-Info | CGI-InfoNR |

OPTIONAL
]]
}

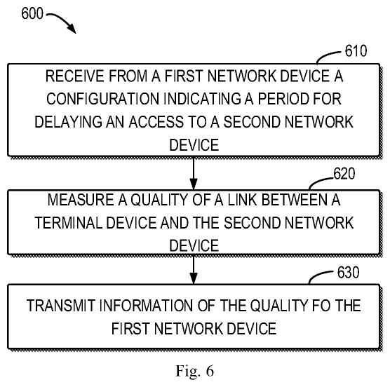

FIG. 6 shows a flowchart of an example method 400 in accordance with an embodiment of the present disclosure. Only for the purpose of illustrations, the method 400 can be implemented at a terminal device 110-1 as shown in FIG. 1.

At block 610, the terminal device 110-1 receives a configuration from the first network device 120-1. The configuration indicates a period for delaying an access to the second network device 120-2. The period may be an extended period. In this way, unnecessary handover/cell reselection is avoided.

In some example embodiments, the period may be a time-to-trigger period. The time-to-trigger specifies the value range used for time to trigger parameter, which concerns the time during which specific criteria for the event needs to be met in order to trigger a measurement report. Only as an example, the time-to-trigger may be extended with 10240 ms and/or 20480 ms. It should be noted that the time-to-trigger period may comprise any suitable period.

Alternatively or in addition, the configuration may a cell-reselection period. The configuration may indicate an offset to a current cell-reselection period. For example, if the current cell-reselection period is 7 seconds and the offset is 8 seconds, it means that the cell-reselection period is 15 seconds. Alternatively, the configuration may indicate an explicit value of the cell-reselection period.

In some example embodiments, the second network device 120-2 may use a dedicated frequency (for example, unlicensed spectrum). The timer may be only applicable to the dedicated frequency of the second network device 120-2.

At block 620, the terminal device 110-1 measures a quality of a link between the terminal 110-1 device and the second network device 120-2 based on the period. For example, if the period may be a time-to-trigger period, the terminal device 110-1 may measure the quality of the link during the time-to-trigger period. Alternatively, if the period may be the cell-reselection period, the terminal device 110-1 may perform the cell reselection after the cell-reselection period. For example, the terminal device 110-1 may measure link qualities of one or more neighbor cells for the cell reselection. In some embodiments, the quality of the link may be RSRP. Alternatively, the quality of the link may be reference signal received quality RSRQ. In other embodiments, the quality of the link may be a received signal level.

At block 630, the terminal device 110-1 transmits information of the quality to the first network device 120-1. For example, in an example embodiment where the period may be a time-to-trigger period, if the quality measured during the time-to-trigger period exceeds a threshold quality, the terminal device 110-1 transmits the information of the quality to the first network device 120-1. Alternatively, if the period is cell-reselection period, the information of the quality may be transmitted after the measurement.

In some embodiments, the terminal device 110-1 may access to the second network device 120-2 which is moving in a speed. The speed may exceed a threshold speed. The terminal device 110-1 may receive system information from the second network device 120-2. In some embodiments, the system information may indicate the cell-reselection periods. Alternatively or in addition, a drx-LongCycleStartOffset may be in the system information. It should be noted that embodiments of the present discourse are not limited to this aspect.

For example, a first measurement configuration is generated, which is applicable when the second network device 120-2 moves in the speed exceeding the threshold speed. The terminal device 110-1 may perform less measurement based on the first measurement configuration. Alternatively or in addition, a second measurement configuration is generated, which is applicable when the second network device 120-2 moves in the speed below the threshold speed.

In some embodiments, the terminal device 110-1 may receive a conditional handover configuration which indicates a condition for handover to a target network device. The conditional handover configuration may be received from the first network device 120-1. In other embodiments, the conditional handover configuration may be forwarded by the second network device 120-2.

In some embodiments, the condition may indicate that the conditional handover is triggered if quality of a link of the target network device is better than a threshold quality. Alternatively or in addition, the condition may indicate the conditional handover is triggered if power changes of signals received from the second network device exceed a threshold power during a predetermined period. It should be noted that the condition may comprise any suitable measurement events, for example, A3 measurement event or A5 measurement event. The terminal device 110-1 may determine whether the condition is satisfied. If the condition is satisfied, the terminal device 110-1 may handover to the target network device.

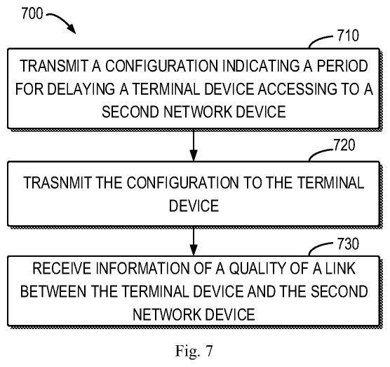

FIG. 7 shows a flowchart of an example method 700 in accordance with an embodiment of the present disclosure. Only for the purpose of illustrations, the method 500 can be implemented at a first network device 120-1 as shown in FIG. 1.

At block 710, the first network device 120-1 generates a configuration that indicates a period for delaying an access to the second network device 120-2. At block 720, the first network device 120-1 transmits the configuration to the terminal device 110-1. In this way, unnecessary handover/cell reselection is avoided.

In some example embodiments, the period may be a time-to-trigger period. The time-to-trigger specifies the value range used for time to trigger parameter, which concerns the time during which specific criteria for the event needs to be met in order to trigger a measurement report. Only as an example, the time-to-trigger may be extended with 10240 ms and/or 20480 ms. It should be noted that the time-to-trigger period may comprise any suitable period.

Alternatively or in addition, the configuration may a cell-reselection period. The configuration may indicate an offset to a current cell-reselection period. For example, if the current cell-reselection period is 7 seconds and the offset is 8 seconds, it means that the cell-reselection period is 15 seconds. Alternatively, the configuration may indicate an explicit value of the cell-reselection period.

In some example embodiments, the second network device 120-2 may use a dedicated frequency (for example, unlicensed spectrum). The period may be only applicable to the dedicated frequency of the second network device 120-2.

At block 730, the first network device 120-1 receives information of the quality from the terminal device 110-1. For example, in an example embodiment where the period may be a time-to-trigger period, if the quality measured during the extended time-to-trigger period exceeds a threshold quality, the terminal device 110-1 transmits the information of the quality to the first network device 120-1. Alternatively, if the period is cell-reselection period, the information of the quality may be transmitted after the measurement.

In some embodiments, the first network device 120-1 may determine whether the second network device 120-2 moves in a speed which exceeds a threshold speed. In some example embodiments, the second network device 120-2 may transmit an indication to the first network device 120-1. The indication may indicate that the speed exceeds the threshold speed. For example, the indication may be transmitted in F1 application protocol (F1-AP) signaling. Alternatively or in addition, the third network device 120-3 may transmit a handover request to the first network device 120-1, which means that the speed exceeds the threshold speed.

In some embodiments, the first network device 120-1 may generate system information which indicates a measurement parameter for measurements on the link quality. For example, the measurement parameter may be a measurement gap which is longer than current measurement gap. Alternatively or in addition, the measurement parameter may be a reduced number of times of measurements. It should be noted that the measurement parameter can be any suitable parameters. In this way, the terminal device 110-1 does not need to perform unnecessary measurement, thereby saving resources and power.

In some embodiments, the system information may indicate the cell-reselection periods. Alternatively or in addition, a drx-LongCycleStart Offset may be in the system information. It should be noted that embodiments of the present discourse are not limited to this aspect.

In other embodiments, the first network device 120-1 may generate more than one measurement configuration. For example, a first measurement configuration is generated, which is applicable when the second network device 120-2 moves in the speed exceeding the threshold speed. The terminal device 110-1 may perform less measurement based on the first measurement configuration. Alternatively or in addition, a second measurement configuration is generated, which is applicable when the second network device 120-2 moves in the speed below the threshold speed.

In some embodiments, the first network device 120-1 may transmit the system information to the third network device 120-3. For example, the system information may be transmitted in F1-AP signaling.

In some embodiments, the first network device 120-1 may determine that that a duration of the first network device 120-1 serving the second network device 120-2 exceeds a threshold value. The first network device 120-1 may generate further system information. For example, the system information may indicate a further measurement parameter for performing the measurement on the link quality. Alternatively, the system information may comprise a normal cell-reselection period. The first network device 120-1 may transmit 3045 the further system information to the second network device 120-2.

Alternatively, the first network device 120-1 may transmit a conditional handover (CHO) configuration associated with the third network device 120-3 to the second network device 120-2. The conditional handover configuration may indicate a condition for handover to a target network device. For example, the first network device 120-1 may configure A4 measurement event as CHO triggering event to the second network device 120-2. In some embodiments, the condition may indicate that conditional handover is triggered if quality of a link of a target network device is better than a threshold quality. Alternatively or in addition, the condition may indicate that the conditional handover is triggered if power changes of signals received from the first network device 120-1 exceed a threshold power during a predetermined period. The threshold power can be determined as any suitable power. The threshold quality can be any suitable quality. In this way, the load balancing of the first network device can be achieved. Further, since there is no modification to the terminal device, the CHO can also be compatible with conventional terminal devices.

In other embodiments, the condition of the CHO may comprise an A3 measurement event. Alternatively, the condition of the CHO may comprise an A5 measurement event. It should be noted that the CHO configuration may comprise any suitable conditions for the CHO.

Alternatively or in addition, the first network device 120-1 may transmit a further CHO configuration to the terminal device 110. The further CHO configuration may also indicate a further condition for handover to a further target network device. In some embodiments, the further CHO configuration may be the same as the CHO configuration. Alternatively, the further CHO configuration may be different from the CHO configuration.

Similarly, the further condition may indicate that conditional handover is triggered if quality of a link of the further target network device is better than a further threshold quality. Alternatively or in addition, the further condition may indicate that the conditional handover is triggered if power changes of signals received from the first network device 120-1 exceed a further threshold power during a further predetermined period. The further threshold power can be determined as any suitable power. The further threshold quality can be any suitable quality. In this way, the load balancing of the first network device can be achieved.

In other embodiments, the further condition of the CHO may comprise an A3 measurement event. Alternatively, the condition of the CHO may comprise an A5 measurement event. It should be noted that the further CHO configuration may comprise any suitable conditions for the CHO.

In some embodiments, the first network device 120-1 may transmit a measurement configuration to the second network device 120-2. The measurement configuration may be for measuring power changes of signals received from the first network device 120-1 in a predetermined period. The measurement configuration may indicate the predetermined period and a threshold power.

The measurement configuration may comprise the following: if Ms−Mslow−Hys>Thresh, the second network device 120-2 may enter the new measurement event. If Ms−Mslow+Hys<Thresh, the second network device 120-2 may leave the new measurement event. The parameter “Ms” represents the latest measurement result of the serving cell (for example, the first network device 110-1), the parameter “Mslow” represents the lowest measurement result of the serving cell during the last Tdelta, the parameter “Hys” represents the hysteresis parameter for this event (i.e. hysteresis as defined within reportConfigNR for this event), and the parameter “Thresh” represents the threshold parameter for this event.

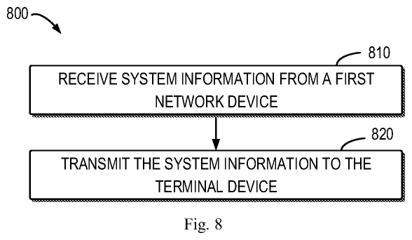

FIG. 8 shows a flowchart of an example method 800 in accordance with an embodiment of the present disclosure. Only for the purpose of illustrations, the method 900 can be implemented at a second network device 120-1 as shown in FIG. 1.

At block 810, the second network device 120-2 receives the system information which indicates a measurement parameter for measurements on the link quality from the first network device 120-1. For example, the system information may be transmitted in F1-AP signaling. For example, the measurement parameter may be a measurement gap which is longer than current measurement gap. Alternatively or in addition, the measurement parameter may be a reduced number of times of measurements. It should be noted that the measurement parameter can be any suitable parameters.

In some embodiments, the system information may indicate the cell-reselection periods. Alternatively or in addition, a drx-LongCycleStartOffset may be in the system information. It should be noted that embodiments of the present discourse are not limited to this aspect.

The second network device 120-2 may update previous system information based on the received system information. The second network device 120-2 may determine 3030 which one of the measurement configurations to be applied based on its speed. The second network device 120-1 may transmit 3035 the system information to the terminal device 110-1. For example, the system information may be broadcasted.

At block 820, the second network device 120-1 may transmit the system information to the terminal device 110-1. For example, the system information may be broadcasted.

In an example embodiment, the second network device 120-2 may be configured with a conditional handover. By way of example, A4 measurement event is used to implement load balancing. he second network device 120-2 may transmit 4010 measurement results to the first network device. The measurement results may indicate qualities of the links between the second network device 120-2 and other network devices (for example, the third network device 120-3).

In some embodiments, the second network device 120-2 may receive a conditional handover (CHO) configuration associated with the third network device 120-3 from the first network device 120-1. The CHO configuration may indicate a condition for handover to a target network device (for example, the third network device). In some embodiments, the first network device 120-1 may configure A4 measurement event as CHO triggering event to the second network device 120-2. For example, the condition may indicate the conditional handover is triggered if quality of a link of the target network device is better than a threshold quality. Alternatively or in addition, the first network device 120-1 may configure A7 measurement event as CHO triggering event. For example, the condition may indicate that the conditional handover is triggered if power changes of signals received from the first network device 120-1 exceed a threshold power during a predetermined period.

In other embodiments, the condition of the CHO may comprise an A3 measurement event. Alternatively, the condition of the CHO may comprise an A5 measurement event. It should be noted that the CHO configuration may comprise any suitable conditions for the CHO.

The second network device 120-2 may determine whether the condition is satisfied. If the condition is satisfied, the second network device 120-2 may perform CHO to the third network device 120-3 based on the A4 event.

Alternatively, the second network device 120-2 may be configured with a new measurement event, in order to prevent ping-pong handover of the terminal device 110-2 between the first network device 120-1 and the second network device 120-2.

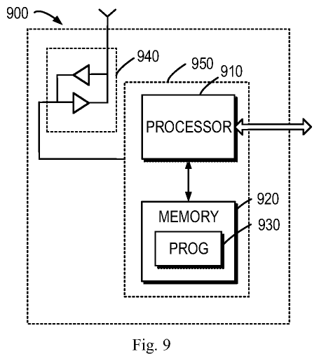

FIG. 9 is a simplified block diagram of a device 900 that is suitable for implementing embodiments of the present disclosure. The device 900 can be considered as a further example implementation of the terminal device 110 and the network device 120 as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 2 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 650 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method comprising:
receiving, at a terminal device, a configuration from a first network device, the configuration indicating a period for delaying an access to a second network device;
measuring, based on the period, a quality of a link between the terminal device and the second network device; and
transmitting information of the quality to the first network device.

2. The method of claim 1, wherein the period comprises a time-to-trigger period, and wherein measuring the quality comprises:
measuring the quality of the link during the time-to-trigger period for handover to the second network device, and
wherein transmitting the information of the quality comprises:
in accordance with a determination that the quality measured during the period exceeds a threshold quality, transmitting the information of the quality to the first network device.

3. The method of claim 1, wherein the period comprises a cell-reselection period, and wherein measuring the quality comprises:
measuring the quality of the link after the cell-reselection period.

4. The method of claim 3, wherein the configuration indicates an explicit value of the period, or the configuration indicates an offset placed to an original cell-reselection period.

5. The method of claim 1, wherein the configuration indicates that the period is applicable to a predetermined working frequency of the second network device.

6. The method of claim 1, further comprising:
accessing to the second network device; and
receiving, from the second network device, system information indicating the number of times of measurements on the quality of the link.

7. The method of claim 1, further comprising:
receiving, from the first network device, a conditional handover configuration which indicates a condition for handover to a target network device; and
in accordance with a determination that the condition is satisfied, performing a handover to the target network device.

8. The method of claim 7, wherein the condition indicates at least one of:
the conditional handover is triggered if quality of a link of the target network device is better than a threshold quality, and
the conditional handover is triggered if power changes of signals received from the first network device exceed a threshold power during a predetermined period.

9. A communication method comprising:
determining, at a first network device, a configuration indicating a period for delaying a terminal device accessing to a second network device;
transmitting the configuration to the terminal device; and
receiving, from the terminal device, information of a quality of a link between the terminal device and the second network device.

10. The method of claim 9, wherein the period comprises a time-to-trigger period and the quality of the link is measured during the time-to-trigger period.

11. The method of claim 9, wherein the period comprises a cell-reselection period, and wherein the link quality is measured after the cell-reselection period.

12. The method of claim 11, wherein the configuration indicates an explicit value of the period, or the configuration indicates an offset placed to an original cell-reselection period.

13. The method of claim 9, further comprising:
determining that the second network device moves in a speed which exceeds a threshold speed;
generating system information indicating a measurement parameter for measurements on the link quality; and
transmitting the system information to the second network device.

14. The method of claim 13, wherein the second network device moving in the speed is determined by at least one of:
receiving from the second network device an indication comprising a parameter related to the speed of the second network device; or
receiving from a third network device a handover request to handover the second network device to the first network device.

15. The method of claim 13, further comprising:
determining that a duration of the first network device serving the second network device exceeds a threshold value;
generating further system information indicating a further measurement parameter for the measurements on the link quality; and
transmitting the further system information to the second network device.

16. The method of claim 13, wherein generating the system information comprises:
generating a first measurement configuration which is applicable if the speed exceeds the threshold speed; and
generating a second measurement configuration which is applicable if the speed is below the threshold speed.

17. The method of claim 9, further comprising:
determining, at the first network device, a conditional handover configuration which indicates a condition for handover to a target network device; and
transmitting to the second network device the conditional handover configuration associated with the target network device.

18. The method of claim 17, wherein the condition indicates at least one of:
the conditional handover is triggered if quality of a link of the target network device is better than a threshold quality, or
the conditional handover is triggered if power changes of signals received from the first network device exceed a threshold power during a predetermined period.

19. The method of claim 9, further comprising:
transmitting to the second network device a measurement configuration for measuring power changes of signals received from the first network device in a predetermined period, the measurement configuration indicating the predetermined period and a threshold power; and
receiving from the second network device information of the power changes.

20. The method of claim 19, wherein the first network device is serving the second network device and a third network device is serving the terminal device, the method further comprising:
in accordance with a determination that the power changes exceed the threshold power during the predetermined period, transmitting the information of the power changes to the third device.

21. A communication method comprising:
receiving, at a second network device and from a first network device, system information indicating a measurement parameter for measurements on a link quality between a terminal device and the second network device; and
transmitting the system information to the terminal device.

22. The method of claim 21, wherein receiving the system information comprises:
determining that a speed of the second network device exceeds a threshold speed; and
transmitting an indication comprising a parameter related to the speed of the second network device.

23. The method of claim 21, where receiving the system information comprises:
receiving the system information indicating a first measurement configuration which is applicable if the speed exceeds the threshold speed and a second measurement configuration which is applicable if the speed is below the threshold speed.

24. The method of claim 23, wherein transmitting the system information to the second network device comprises:
determining whether that the speed exceeds the threshold speed;
in accordance with a determination that the speed exceeds the threshold speed, transmitting to the terminal device the system information indicating the first measurement configuration; or
in accordance with a determination that the speed is below the threshold speed, transmitting to the terminal device the system information indicating the second measurement configuration.

25. The method of claim 21, further comprising:
receiving from the first network device a conditional handover configuration which indicates a condition for handover to a target network device; and
in accordance with a determination that the condition is satisfied, performing a handover to the target network device.

26. The method of claim 25, wherein the condition indicates at least one of:
the conditional handover is triggered if quality of a link of the target network device is better than a threshold quality, and
the conditional handover is triggered if power changes of signals received from the first network device exceed a threshold power during a predetermined period.

27. The method of claim 21, further comprising:
receiving from the first network device a measurement configuration for measuring power changes of signals received from the first network device in a predetermined period, the measurement configuration indicating the predetermined period and a threshold power;
measuring the power changes based on the measurement configuration; and
transmitting to the first network device information of the power changes.

28. A terminal device, comprising:
a processing unit; and
a memory coupled to the processing unit and storing instructions thereon, the instructions, when executed by the processing unit, causing the terminal device to perform the method according to any one of claims 1-8.

29. A first network device, comprising:
a processing unit; and
a memory coupled to the processing unit and storing instructions thereon, the instructions, when executed by the processing unit, causing the first network device to perform the method according to any one of claims 9-20.

30. A second network device, comprising:
a processing unit; and
a memory coupled to the processing unit and storing instructions thereon, the instructions, when executed by the processing unit, causing the second network device to perform the method according to any one of claims 21-27.

31. A computer readable medium having instructions stored thereon, the instructions, when executed on at least one processor, causing the at least one processor to carry out the method according to any one of claims 1-8.

32. A computer readable medium having instructions stored thereon, the instructions, when executed on at least one processor, causing the at least one processor to carry out the method according to any one of claims 9-20.

33. A computer readable medium having instructions stored thereon, the instructions, when executed on at least one processor, causing the at least one processor to carry out the method according to any one of claims 21-27.
